(19) United States
(12) Patent Application Publication
(10) Pub. No.: US 2009/0084726 A1
(43) Pub. Date: Apr. 2, 2009

(54) MULTI-FUNCTIONAL DUAL FILTERING KETTLE

(76) Inventor: Tsung-Hui Lee, Tau Yuan Hsien (TW)

Correspondence Address: TSUNG-HUI LEE, 235 Chung - Ho, Box 8-24, Taipei, TW

(21) Appl. No.: 11/863,249

(22) Filed: Sep. 28, 2007

(51) Int. Cl. B01D 39/20

(52) U.S. Cl. 210/486; 210/489

(57) ABSTRACT

A multi-functional dual filtering kettle comprises a kettle body; a filter received in the kettle body; a cover covering upon an upper opening of the kettle body; an inner side of the filter having a ceramic filter unit and a compound filter unit being installed below the filter. The ceramic filter unit has the function of emitting far field infrared rays; and the compound filter unit filter has the function of removing the impurities, microorganisms, odor, and organic compounds in water. The ceramic filter unit has a plurality of biochemical ceramic balls which has the function of emitting far field infrared rays. A hollow space of the compound filter unit is filled with a filter layer, an active carbon layer, and a ceramic layer.

### FIELD OF THE INVENTION

The present invention relates to filters, and particularly to a multi-functional dual filtering kettle which has a ceramic filter unit and a compound filter unit. The ceramic filter unit has the function of emitting far field infrared rays; and the compound filter unit filter has the function of removing the impurities, microorganisms, odor, and organic compounds in water.

### BACKGROUND OF THE INVENTION

General home used water contains impurities, such as tiny sands, bacteria, heavy metal particles, etc. If the water is not further processed, the health of the drinker will have bad effect for a long time. However some home used filters has complicated structure and must be installed by professional workers. The maintenance can not be done by users themselves and pipe lines can not be moved as desired. Thus these kinds of filters are only used at home. Furthermore, the prices are high. To update the filter unit needs a long time. Thus the prior art filter is necessary to be improved.

### SUMMARY OF THE INVENTION

Accordingly, the primary object of the present invention is to provide a multi-functional dual filtering kettle which has a ceramic filter unit and a compound filter unit. The ceramic filter unit has the function of emitting far field infrared rays; and the compound filter unit filter has the function of removing the impurities, microorganisms, odor, and organic compounds in water.

To achieve above objects, the present invention provides a multi-functional dual filtering kettle, comprising; a kettle body; a filter received in the kettle body; a cover covering upon an upper opening of the kettle body; an upper edge of the filter being formed with a flange; an inner side of the filter having a ceramic filter unit and a compound filter unit being installed below the filter. The ceramic filter unit has the function of emitting far field infrared rays; and the compound filter unit has the function of removing the impurities, microorganisms, odor, and organic compounds in water.

A hollow space of the ceramic filter unit has a plurality of biochemical ceramic balls which has the function of emitting far field infrared rays. A hollow space of the compound filter unit is filled with a filter layer, an active carbon layer, and a ceramic layer. The filter layer serves to filter the impurities and microorganisms in water; the active carbon layer has the effect of removing odor, impurities, and organic compounds; the ceramic layer has the effect of emitting far field infrared rays.

The various objects and advantages of the present invention will be more readily understood from the following detailed description when read in conjunction with the appended drawing.

### BRIEF DESCRIPTION OF THE DRAWINGS

FIG. 1 is an explosive schematic view of the present invention.

FIG. 2 is an assembled schematic view of the present invention.

FIG. 3 is a schematic view includes a compound filter unit of the present invention.

FIG. 4 is a schematic view showing the ceramic filter unit according to the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

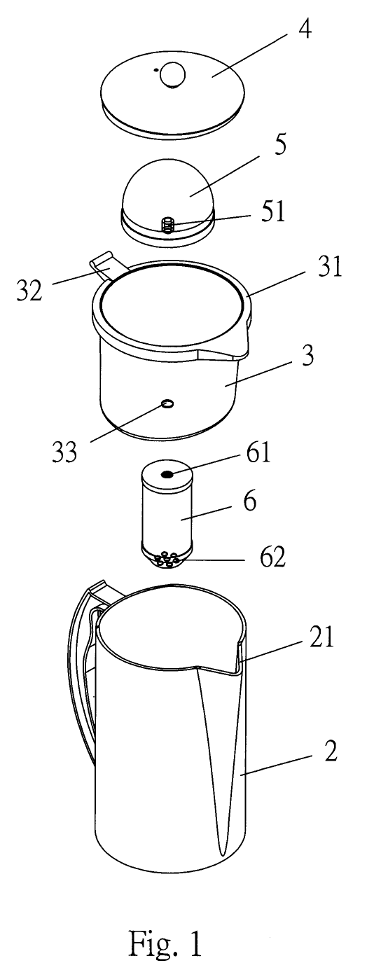

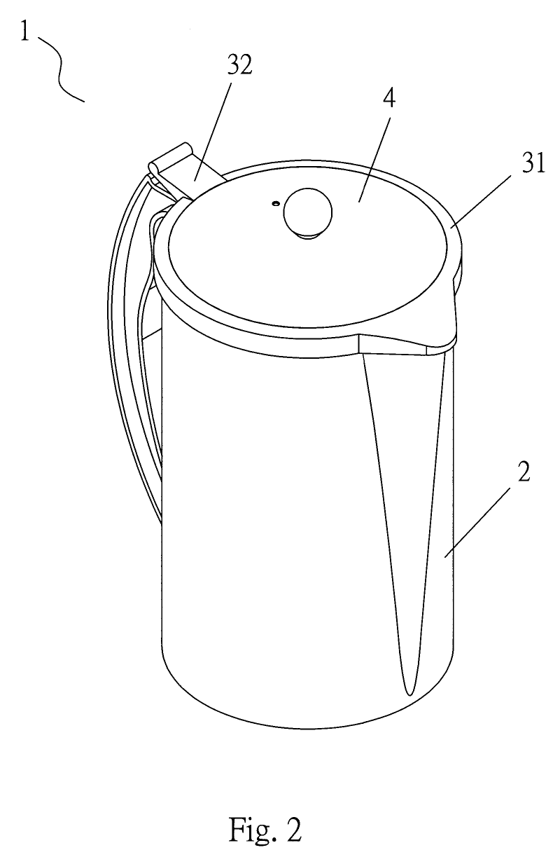

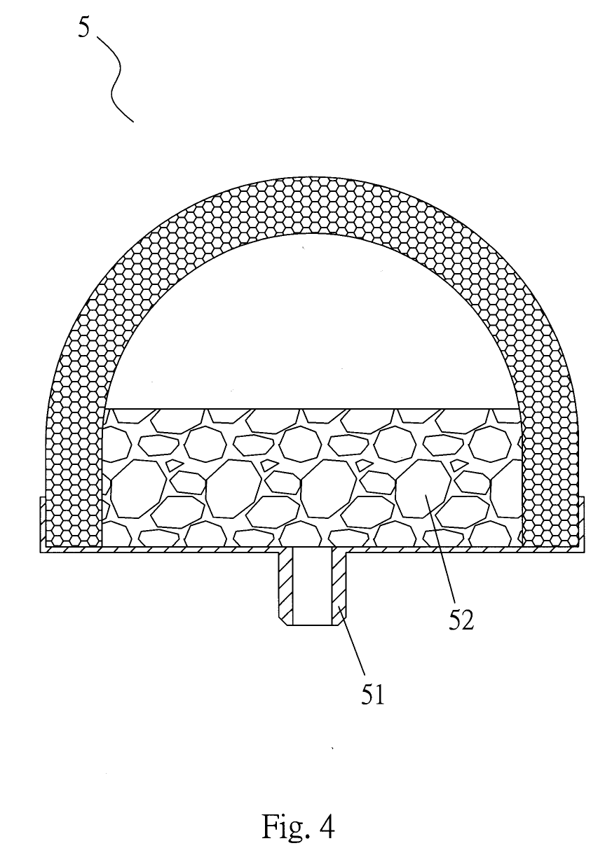

Referring to FIGS. 1 to 4, the multi-functional dual filtering kettle 1 according to the present invention is illustrated. The present invention has the following elements.

A kettle body 2 is included.

A filter 3 is received in the kettle body 1.

A cover 4 covers upon an upper opening of the kettle body 1. An upper edge of the filter 3 is formed with a flange 31. A press key 32 is protruded from the flange 31. When the filter 3 is received in the kettle body 1 and the flange 31 of the filter 3 is buckled at the opening 21 at an upper side of the kettle body 1. A bottom of the filter 3 has a via hole 33.

An inner side of the filter 3 has a ceramic filter unit 5 and a compound filter unit 6 is installed below the filter 3.

The ceramic filter unit 5 has a hemispherical shape. A lower side of the ceramic filter unit 5 is formed with a threaded portion 51. The threaded portion 51 and the hemispherical portion have hollow interiors.

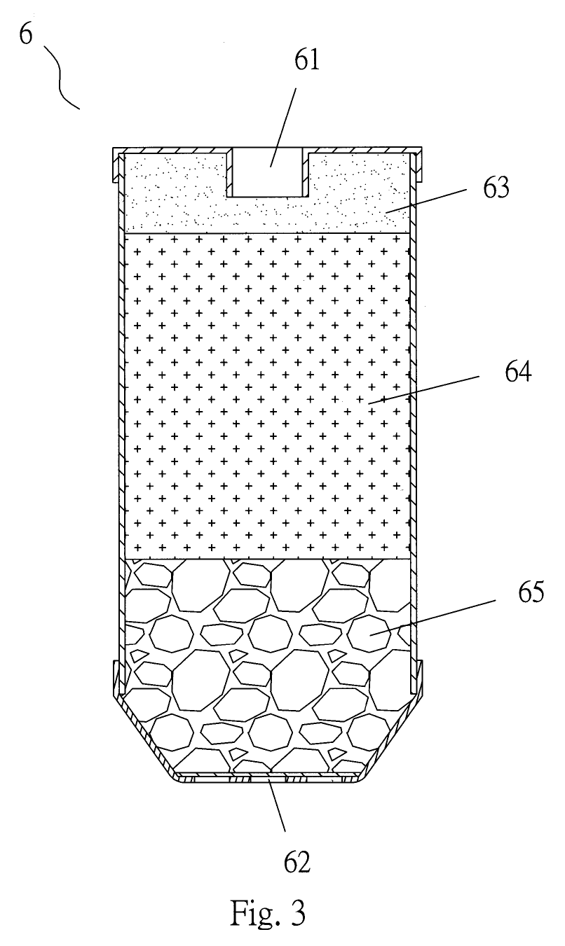

The compound filter unit 6 has a post like structure and has a hollow interior. A top of the compound filter unit 6 is a threaded groove 61. A lower end of the compound filter unit 6 has an outlet 63. A hollow space of the compound filter unit 6 is filled with a filter layer 63, an active carbon layer 64, and a ceramic layer 65 (referring to FIG. 3). The filter layer 63 serves to filter the impurities and microorganisms in water. The active carbon layer 64 has the effect of removing odor, impurities, and organic compounds. The ceramic layer 65 has the effect of emitting far field infrared rays. By above mentioned structure, water flowing into the filer 3 will permeate into the ceramic filter unit 5 to react with the biochemical ceramic balls 52 and then flows to the filtering layer 63, active carbon layer 64 and ceramic layer 65 in the compound filter unit 6. Then the water flows out from the outlet 63 to the lower space of the kettle body 2. If it is desired to take the filtered water, it is only necessary to press the press key 32 to make the water flows out from the outlet 63 of the kettle body 1.

In the present invention, the ceramic filter unit 5 and compound filter unit 6 have dual effects to filter water so as to have the function of removing impurities, odor and suppressing bacteria. The biochemical ceramic balls 52 and ceramic layer 65 will make the water molecules being small, containing higher density of calcium, and alkaline activation.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A multi-functional dual filtering kettle, comprising;
a kettle body;
a filter received in the kettle body;
an inner side of the filter having a ceramic filter unit and a compound filter unit installed below the ceramic filter;
wherein the ceramic filter unit has the function of emitting far field infrared rays; and the compound filter unit filter has the function of removing impurities, microorganisms, odor, and organic compounds in water.

2. The multi-functional dual filtering kettle, wherein a hollow space of the ceramic filter unit has a plurality of biochemical ceramic balls which has the function of emitting far field infrared rays.

3. The multi-functional dual filtering kettle as claimed in claim 1, wherein a hollow space of the compound filter unit is filled with a filter layer, an active carbon layer, and a ceramic layer; the filter layer serves to filter the impurities and microorganisms in water; the active carbon layer has the effect of removing odor, impurities, and organic compounds; the ceramic layer has the effect of emitting far field infrared rays.

4. The multi-functional dual filtering kettle as claimed in claim 1, wherein a press key is protruded from the flange.

5. The multi-functional dual filtering kettle as claimed in claim 1, wherein the ceramic filter unit has a hemispherical shape; a lower side of the ceramic filter unit is formed with a threaded portion; and the threaded portion and the hemispherical portion have hollow interiors.

6. The multi-functional dual filtering kettle as claimed in claim 5, wherein the compound filter unit has a post like structure and has a hollow interior; and a top of the compound filter unit is a threaded groove.

7. The multi-functional dual filtering kettle as claimed in claim 1, wherein a bottom of the filter has a via hole.

8. The multi-functional dual filtering kettle as claimed in claim 1, wherein an upper edge of the filter is formed with a flange.

9. The multi-functional dual filtering kettle as claimed in claim 1, wherein a cover covers upon an upper opening of the kettle body.
